(19) United States
(12) Patent Application Publication
(10) Pub. No.: US 2019/0069662 A1
(43) Pub. Date: Mar. 7, 2019

(54) Dual density blending sponge

(71) Applicant: Orchard International Inc., a corporation of Ontario, Canada, Mississauga (CA)

(72) Inventor: Shelley Peters, Alton (CA)

(73) Assignee: Orchard International Inc.

(21) Appl. No.: 15/732,037

(22) Filed: Sep. 7, 2017

(51) Int. Cl. A45D 34/04; B29C 44/04

(52) U.S. Cl. CPC A45D 34/04; B29K 2075/00; A45D 2200/1009; B29C 44/04

(57) ABSTRACT

A makeup sponge has first and second polyurethane portions each defining a three dimensional body. The portions are of easily differentiated colors and are attached along a line of attachment by polyurethane adhesive. The density of the first portion is typically about 80 kg/m³˜130 kg/m³ and the pore size about 30-60 PPI (pores per linear inch) to achieve a light to medium makeup coverage. The density of the second portion is typically about 150 kg/m³˜200 kg/m³ with a pore size of about 100-150 PPI to achieve a medium to heavy expert makeup coverage. The sponge may have a pointed tip and flat base opposite the tip, and is utilizable to apply all types of makeup including foundation, concealer, and contour makeups.

### BACKGROUND AND SUMMARY OF THE INVENTION

For proper makeup application many people need to purchase and utilize sponges with different properties. For example sponges with one density characteristic are used to achieve a lightweight, airbrushed, coverage while sponges with a different density are used for a more expert heavier application. The conventional use of a plurality of different sponges with different densities is illustrated, for example, in US Published Patent Application 2004/0004087.

According to the invention, a makeup sponge is provided that allows the application of makeup in different manners utilizing the same device. The sponge of the invention has two or more different portions that have different densities and porosities. At least one of the portions has a relatively high density and low porosity so that it is appropriate or optimal for a medium to heavy expert coverage, ideal for all-over foundation, contouring and heavier color applications. At least one other portion has a relatively low density and high porosity so that it is appropriate or optimal for achieving a light to medium coverage, ideal for an airbrushed concealer effect, highlighter/illuminator, blending out lines and sheering foundation.

In a preferred embodiment the sponge has two different portions separated along a substantially vertical line, when the sponge is in a normal at rest orientation with a tip at the top and base at the bottom. The portions may be of substantially equal size. The sponge may have a generally tear-dropped shape, with a rounded base or alternatively with a substantially flat base, and a substantially pointed tip opposite the base. In another embodiment the sponge has two different portions separated along a substantially horizontal line, when the sponge is in a normal at rest orientation with the tip at the top. Other vastly different configurations of the sponge are also possible, including almost any prior art configuration.

It is desirable that the sponge be made of polyurethane. The two (or more) portions of the sponge are preferably attached together by polyurethane glue, although in some circumstances it is possible to attached the portions together with some sort of plastics welding technique, such as ultrasonic or laser.

The density range of the sponge is preferably 80 kg/m³˜200 kg/m³. The porosity of the portion for applying light to medium coverage is less than 80 PPI (pores per linear inch), typically about 30-60 PPI, with a density of about 80 kg/m³˜130 kg/m³. The porosity of the portion for applying medium to heavy coverage is greater than 80 PPI, typically about 100-150 PPI, with a density of about 150 kg/m³˜200 kg/m³.

That is, according to a first aspect of the present invention there is provided a makeup sponge having first and second portions, both being three dimensional bodies attached together along a line of attachment. [The term “three dimensional” means that the body has significant height, width, and depth dimension, and is clearly not substantially planar.] The first portion has density and pore size characteristics for achieving a light to medium makeup coverage, and the second portion has density and pore size characteristics at least 20% different (e. g. 30-60% different) from the first portion and is for achieving a medium to heavy expert makeup coverage. Desirably first and second portions are of polyurethane sponge material and are attached together along the line of attachment by polyurethane adhesive.

Typically, the first portion has a pore size of less than 80 PPI (preferably about 30-60 PPI), with a density of about 80 kg/m³˜130 kg/m³, and the second portion has a pore size of greater than 80 PPI (preferably about 100-150 PPI), with a density of about 150 kg/m³˜200 kg/m³. Desirably the first and second portions form a three dimensional body having a substantially tear-shaped configuration with a substantially pointed tip and a substantially flat base opposite the tip. The line of attachment may bisect the sponge extending from the tip to the base, and the first and second portions are the only portions of the sponge; alternatively, the line of attachment may be substantially parallel to the flat base. In some circumstances the base may be generally rounded.

Desirably, the first and second portions are of easily distinguished different colors (e. g. black and red, or pink and blue).

According to another aspect of the invention there is provided a makeup sponge having first and second portions, both being three dimensional bodies attached together along a line of attachment. The first portion has a pore size of less than 80 PPI, with a density of about 80 kg/m³˜130 kg/m³, and the second portion has a pore size of greater than 80 PPI, with a density of about 150 kg/m³˜200 kg/m³. Other details are preferably as described with respect to the first embodiment.

According to yet another aspect of the invention there is provided a method of utilizing a makeup sponge having first and second portions with distinctly (e. g. at least about 20%, preferably about 30-60%) different densities and pore size, comprising:

a) moving the first portion of the sponge into contact with liquid and/or cream formulation makeup comprising one or more of concealer, foundation, BB/CC cream, highlighter, blush, powder formulations, and contouring makeup;

b) bringing the first portion into contact with a human user's skin to achieve a light to medium coverage, ideal for an airbrushed concealer effect, highlighter/illuminator, blending out lines and sheeting foundation;

c) moving the second portion of the sponge into contact with liquid and/or cream formulation makeup comprising one or more of concealer, foundation, BB/CC cream, highlighter, blush, powder formulations, and contouring makeup;

d) bringing the second portion into contact with a human user's skin to achieve a medium to heavy expert coverage, ideal for all-over foundation, contouring and heavier color applications; and then sometime after b) or d)

e) gently washing and dry storing the sponge.

Desirably the sponge has a substantially pointed tip, and a substantially flat base opposite the tip; and the method further comprises: f) during the practice of b) and/or d) using the substantially pointed tip to apply makeup to hard to reach portions of the human's skin; and g) during or after b) and/or d) using the substantially flat base to blot, blur, and/or stipple.

It is the primary object of the present invention to provide a single makeup sponge for achieving both a lightweight, airbrushed coverage, and a more expert, heavier application, depending upon which portion of the sponge is used, and a method of utilization thereof. This and other objects of the invention will become clear from the detailed description of the invention and from the appended claims.

### BRIEF DESCRIPTION OF THE DRAWINGS

FIG. 1 is a side view of one embodiment of an exemplary dual density makeup sponge according to the present invention;

FIG. 2 is a frontal face view of just the low density portion of the sponge of FIG. 1;

FIG. 3 is a view like that of FIG. 2 of the high density portion;

FIG. 4 is a side view of the two portions of the sponge of FIGS. 1-3 detached from each other with adhesive applied to the faces thereof before joining together to form the sponge of FIG. 1;

FIG. 5 is a view like that of FIG. 1 of another exemplary embodiment of a sponge according to the invention; and

FIG. 6 is a diagrammatic view showing exemplary procedures for the utilization of the sponges of FIGS. 1-5.

### DETAILED DESCRIPTION OF THE DRAWINGS

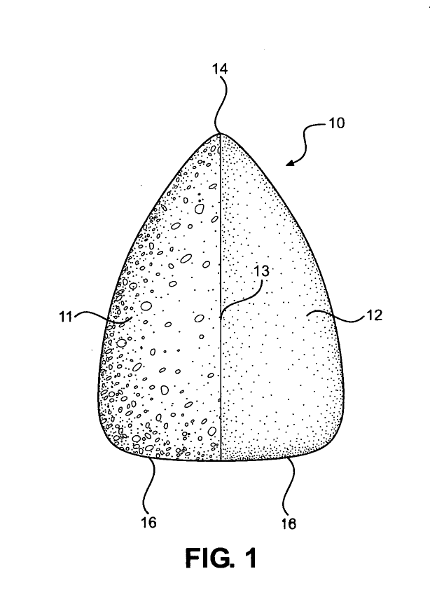

One desirable embodiment of an exemplary sponge according to the invention is illustrated generally by reference numeral 10 in FIGS. 1-4. It comprises at least first portion 11, and second portion 12. The portions 11, 12 are both three dimensional bodies attached together along a line of attachment 13. The first portion 11 has density and pore size characteristics for achieving a light to medium makeup coverage, and the second portion 12 has density and pore size characteristics at least about 20% (e. g. about 25%-60%) different from the first portion and for achieving a medium to heavy expert makeup coverage. While the portions 11, 12 may be made of a wide variety of conventional sponge materials, desirably both portions 11, 12 are of polyurethane sponge material.

The portions 11, 12 are preferably of straightforwardly distinguished different colors so as to easily differentiate between them (e. g. red and black, or pink and blue).

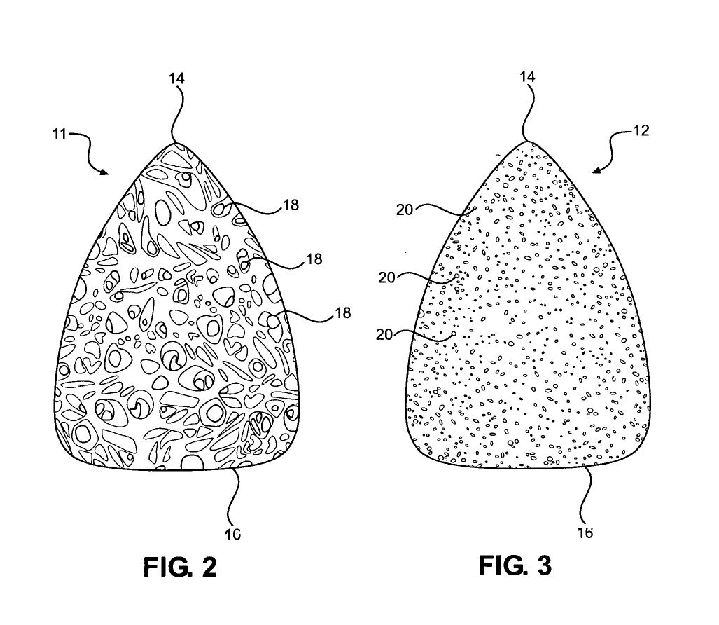

Although a wide variety of shapes may be provided, preferably the sponge 10 has a substantially pointed tip 14, and a substantially flat base 16 opposite the tip. As seen in FIGS. 2 and 3, the pore size is different in the two portions 11, 12. For example the pore size in portion 11, as schematically indicated by numeral 18 (FIG. 2), is such that the pores are large and fewer pores per linear inch (PPI) are provided compared to the second portion 12. The pores 20 in portion 12 (FIG. 3) are smaller and there are more pores per linear inch than for portion 11. The density range for both portions 11, 12 is about 80 kg/m³˜200 kg/m³ with portion 11 having about 30-80 PPI and the portion 12 about 80-150 PPI.

Preferably, the first portion 11 has a pore size of less than 80 PPI, with a density of about 80 kg/m³˜130 kg/m³, and wherein the second portion 12 has a pore size of greater than 80 PPI, with a density of about 150 kg/m³˜200 kg/m³. For example, the first portion 11 may have a pore size of about 30-60 PPI, and the second portion 12 a pore size of about 100-150 PPI.

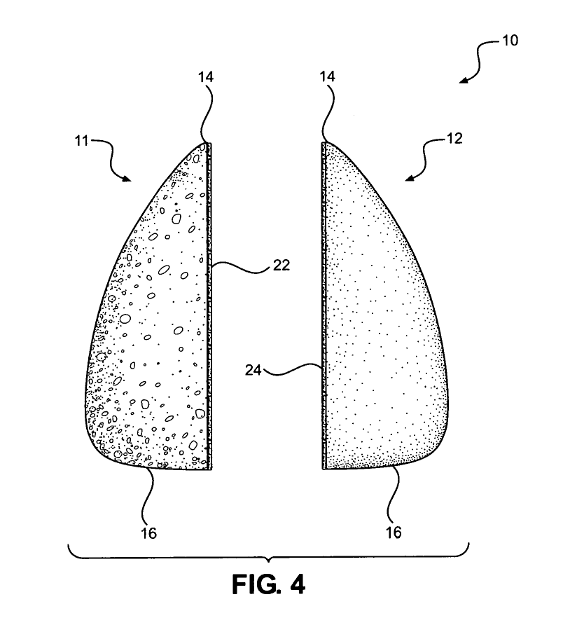

FIG. 4 shows the portions 11, 12 just before then are joined together along the line of attachment. One or both of the faces of the portions 11, 12 to be joined may have a thin adhesive layer 22, 24 which, when the faces abut and the adhesive cures, substantially permanently holds the portions 11, 12 together along the line of attachment 13. Preferably the adhesive 22, 24 is polyurethane adhesive, especially when the portions are of polyurethane sponge material. While adhesive is preferred, in some circumstances it is possible to attach the portions 11, 12 together with some sort of conventional plastics welding technique, such as ultrasonic or laser.

As seen in FIGS. 1-4, the sponge 10 has a generally tear drop configuration, with a substantially pointed tip 14 and a substantially flat base 16 opposite the tip 14; the line of attachment 13 essentially bisects the sponge 10 extending from the tip 14 to the base 16, and is substantially perpendicular to the base 16. However, many other configurations are possible, including most prior art configurations of makeup sponges. For example the base 16 can be rounded and/or apertured, and instead of two different density portions three or more portions may be provided. For example the sponge 10 could have the configuration of a triangular prism or pyramid with three prismatic or pyramidal sections joined together with adhesive.

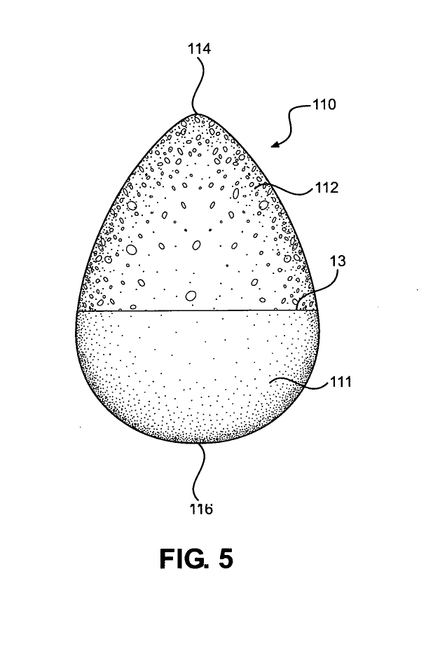

Another embodiment is illustrated in FIG. 5. Components of the embodiment in FIG. 5 comparable to those in FIG. 1 are shown by the same reference numeral only preceded by a “1”.

The sponge 110 has first and second portions 111, 112 joined together along a line of attachment 113, with a substantially pointed tip 114 and a generally rounded base 116 opposite the tip 114. Here the line of attachment 113 is perpendicular to a line bisecting the sponge 110 extending through the tip 114 and base 116. If the base 116 is substantially flat, then the line of attachment will be substantially parallel to the base 116. The characteristics of the portions 111, 112 are as described above with respect to portions 11, 12.

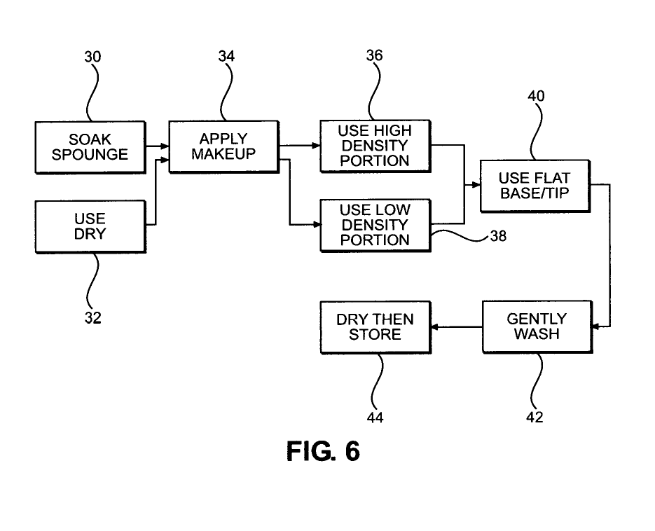

An exemplary method of utilization of the sponges 10, 110 is schematically illustrated in FIG. 6. The method comprises:

As indicated at 30, soaking the sponge 10, 110 with warm water, gently squeezing out any excess. Alternatively, as indicated at 32, the sponge can be used substantially dry.

The first portion 11, 111 of the sponge 10, 110 is then brought into contact with liquid and/or cream formulation makeup comprising one or more of concealer, foundation, BB/CC cream, highlighter, blush, powder formulations, and contouring makeup, as indicated at 34. Then as indicated at 38, the first portion 11, 111 is brought into contact with a human user's skin (usually, but not necessarily, the face) to achieve a light to medium coverage, ideal for an airbrushed concealer effect, highlighter/illuminator, blending out lines and sheering foundation.

The second portion 12, 112 of the sponge 10, 110 is brought into contact with liquid and/or cream formulation makeup comprising one or more of concealer, foundation, BB/CC cream, highlighter, blush, powder formulations, and contouring makeup, again as indicated at 34. Then, instead of or in addition to 38, as indicated at 36, the second portion 12, 112 is brought into contact with a human user's skin to achieve a medium to heavy expert coverage, ideal for all-over foundation, contouring and heavier color applications.

When the desired flat base 16 is provided for the sponge 10, as indicated at 40 the substantially flat base 16 is used to blot, blur, and/or stipple. When a pointed tip 14, 114 is provided, the pointed tip 14, 114 may also be used to apply makeup to hard to reach portions of the human's skin, also as indicated at 40.

Ultimately, after the makeup has been applied, as indicated at 42 the sponge 10, 110 is gently washed preferably with warm water and a gentle cleansing soap or liquid. After washing the sponge is well rinsed and any excess water is squeezed out. Then, as indicated at 44, the sponge 10, 110 is fully dried (preferably simply air dried) before storing it away or re-using it.

During all stages in FIG. 6 it is undesirable to wring or twist the sponge 10, 110, and it is desirable to avoid using fingernails since that could cause the sponge 10, 110 to tear.

While the invention has been herein shown and described in what is presently considered to be the most practical embodiments thereof it is to be understood that the invention is to be broadly interpreted to encompass all equivalent structures and procedures, limited only by the prior art. Also the invention specifically includes all narrow limitations within any broad range; for example (and example only) about 30-60 PPI also specifically includes 29.5-40 PPI, 36-52 PPI, 41-60.5 PPI, and all other narrow ranges within the broad range.

What is claimed is:

1. A makeup sponge having first and second portions; both said first and second portions being three dimensional bodies attached together along a line of attachment; said first portion having density and pore size characteristics for achieving a light to medium makeup coverage; and said second portion having density and pore size characteristics at least 20% different from said first portion and for achieving a medium to heavy expert makeup coverage.

2. A makeup sponge as recited in claim 1 wherein said first and second portions are of polyurethane sponge material.

3. A makeup sponge as recited in claim 2 wherein said first and second portions are attached together along said line of attachment by polyurethane adhesive.

4. A makeup sponge as recited in claim 3 wherein said first portion has a pore size of less than 80 PPI, with a density of about 80 kg/m³˜130 kg/m³, and wherein said second portion has a pore size of greater than 80 PPI, with a density of about 150 kg/m³˜200 kg/m³.

5. A makeup sponge as recited in claim 4 wherein said first portion has a pore size of about 30-60 PPI, and wherein said second portion has a pore size of about 100-150 PPI.

6. A makeup sponge as recited in claim 5 wherein said first and second portions form a three dimensional body having a substantially tear-shaped configuration with a substantially pointed top and a substantially flat base opposite said tip.

7. A makeup sponge as recited in claim 6 wherein said line of attachment substantially bisects said sponge extending from said tip to said base, and said first and second portions are the only portions of said sponge and are of easily differentiated colors.

8. A makeup sponge as recited in claim 6 wherein said line of attachment is substantially parallel to said flat base and wherein said first and second portions are the only portions of said sponge and are of easily differentiated colors.

9. A makeup sponge as recited in claim 1 wherein said sponge comprises a three-dimensional body having a substantially tear-shaped configuration with a substantially pointed tip.

10. A makeup sponge as recited in claim 9 wherein said line of attachment is substantially perpendicular to a line extending through said substantially pointed tip bisecting said sponge, and wherein opposite said substantially pointed tip said sponge has a generally rounded base.

11. A makeup sponge as recited in claim 1 wherein said first portion has a pore size of less than 80 PPI, with a density of about 80 kg/m³˜130 kg/m³, and wherein said second portion has a pore size of greater than 80 PPI, with a density of about 150 kg/m³˜200 kg/m³.

12. A makeup sponge as recited in claim 1 wherein said first portion has a pore size of about 30-60 PPI, and wherein said second portion has a pore size of about 100-150 PPI.

13. A makeup sponge as recited in claim 1 wherein said first and second portions form a three dimensional body having a substantially tear-shaped configuration with a substantially pointed tip and a substantially flat base opposite said tip, and said first and second portions are of easily differentiated different colors.

14. A makeup sponge having first and second portions; both said first and second portions being three dimensional bodies attached together along a line of attachment; said first portion has a pore size of less than 80 PPI, with a density of about 80 kg/m³˜130 kg/m³, and wherein said second portion has a pore size of greater than 80 PPI, with a density of about 150 kg/m³˜200 kg/m³.

15. A makeup sponge as recited in claim 14 wherein said first portion has a pore size of about 30-60 PPI, and wherein said second portion has a pore size of about 100-150 PPI.

16. A makeup sponge as recited in claim 15 wherein said first and second portions form a three dimensional body having a substantially tear-shaped configuration with a substantially pointed tip and a substantially flat base opposite said tip and said first and second portions are of easily differentiated different colors.

17. A makeup sponge as recited in claim 14 wherein said first and second portions are of polyurethane sponge material.

18. A makeup sponge as recited in claim 17 wherein said first and second portions are attached together along said line of attachment by polyurethane adhesive.

19. A method of utilizing a makeup sponge having first and second portions with distinctly different densities and pore size, comprising:
a) moving the first portion of the sponge into contact with liquid and/or cream formulation makeup comprising one or more of concealer, foundation, BB/CC cream, highlighter, blush, powder formulations, and contouring makeup;
b) bringing the first portion into contact with a human user's skin to achieve a light to medium coverage, ideal for an airbrushed concealer effect, highlighter/illuminator, blending out lines and sheering foundation;
c) moving the second portion of the sponge into contact with liquid and/or cream formulation makeup comprising one or more of concealer, foundation, BB/CC cream, highlighter, blush, powder formulations, and contouring makeup;
d) bringing the second portion into contact with a human user's skin to achieve a medium to heavy expert coverage, ideal for all-over foundation, contouring and heavier color applications; and then sometime after b) or d)
e) gently washing and dry storing the sponge.

20. A method as recited in claim 19 wherein the sponge has a substantially pointed tip and a substantially flat base opposite the tip; and further comprising: f) during the practice of b) and/or d) using the substantially pointed tip to apply makeup to hard to reach portions of the human's skin; and g) during or after b) and/or d) using the substantially flat base to blot, blur, and/or stipple.
